(19) United States
(12) Patent Application Publication
(10) Pub. No.: US 2022/0213726 A1
(43) Pub. Date: Jul. 7, 2022

(54) PIECE OF FURNITURE WITH A DOOR HELD BY A DISPLACEMENT DEVICE

(71) Applicant: HAWA SLIDING SOLUTIONS AG, Mettmenstetten (CH)

(72) Inventors: Gregor HAAB, Allenwinden (CH); Pascal PREHM, Untersiggenthal (CH)

(73) Assignee: HAWA SLIDING SOLUTIONS AG, Mettmenstetten (CH)

(21) Appl. No.: 17/608,301

(22) PCT Filed: Jun. 3, 2020
(86) PCT No.: PCT/EP2020/065305

§ 371 Date: Nov. 2, 2021

(30) Foreign Application Priority Data
Jun. 7, 2019 (EP) 19179204.3

(51) Int. Cl. E05D 15/14

(52) U.S. Cl. CPC E05D 15/14

(57) ABSTRACT

The piece of furniture (10) comprises a one-part or multi-part door (11), which serves to close an opening of the piece of furniture (10) and which is connected by hinges (3) to a mounting profile (85) which is held within a door compartment (14) by a displacement device (1) displaceably between a first end position and a second end position, which displacement device (1) has a lever mechanism (5) comprising four lever units (51, 52, 53, 54) rotatable in a plane, a first connection bridge (58A) and a second connection bridge (58B) and a centre bridge (55), which centre bridge (55) is pivotally connected on a first side by a first lever unit (51) and a second lever unit (52), which are spaced apart and aligned parallel to one another, each to the first connection bridge (58A), which is connected to at least one holding device (84A, 84B) mounted on the piece of furniture (10), and which centre bridge (55) is pivotally connected on a second side by a third lever unit (53) and a fourth lever unit (54), which are spaced apart and aligned parallel to one another, each to the second connection bridge (58B), which is connected to the mounting profile (85). According to the invention in the first end position of the mounting profile (85) the lever units (51, 53; 52, 54) are aligned at least approximately parallel to the first and second connection bridge (58A, 58B) and are at least partially sunk into the centre bridge (55), which centre bridge (55) in this first end position of the mounting profile (85) is at least partially sunk into one of the first and second connection bridges (58A, 58B).

The invention relates to a piece of furniture, such as a wardrobe, with a one-part or multi-part door, in particular a foldable sliding door, which is held by a displacement device displaceable into a door compartment.

For closing an opening of a piece of furniture, doors are often used, especially foldable sliding doors, which when the piece of furniture has been opened can be slid into a door compartment. When the piece of furniture is opened, the door is turned to the side or folded. To ensure that the opened door does not appear disturbingly, it is then moved into the door compartment of the piece of furniture, which is usually separated from the interior of the piece of furniture by a partition wall.

U.S. Pat. No. 8,336,972B2 discloses a piece of furniture with a displacement device by means of which a foldable sliding door connected by hinges to a mounting profile can be pulled out of a door compartment, rotated in front of an opening and retracted back into the door compartment. The displacement device comprises a scissor cross which has two scissor elements which are pivotally connected to one another and which hold the mounting profile aligned in a vertical position during displacement within the door compartment. The scissor cross is connected to the mounting profile by a fastening device. After loosening the fastening device, the mounting profile can be moved vertically in relation to the scissor cross in order to position the door within the door compartment at an equal distance from the top and bottom of the piece of furniture.

If no scissors cross is used, it should be noted that parts of the lever mechanism may take up an undefined position before being connected to the mounting profile, so that the optimum position must first be determined with appropriate effort before connecting to the mounting profile.

The mounting profile is not only held by the scissor cross, but is also guided along an upper and a lower rail to avoid twisting and jamming of the scissor cross.

It should also be noted that a displacement device of this type can take up a relatively large amount of space, so that the door held by the displacement device cannot be sunk as far as desired into the door compartment of the piece of furniture. Accordingly, the door or foldable sliding door and its elements need therefore be dimensioned smaller. Alternatively, the door compartment is to be designed accordingly larger, so that the design of the displacement device may have an undesirable influence on the dimensions of the piece of furniture.

EP3029248A1 discloses a displacement device with a lever mechanism, which is designed as a scissor cross or parallelogram and has parallel levers, by means of which a mounting profile, which is hinged to a door, is slidably held.

US2014150208A1 discloses a piece of furniture that comprises a foldable sliding door with several door elements and a guide rail that extends along the front of the piece of furniture and into the door compartment through a 90° curve. In this piece of furniture, the front door element is held by a guide drive that runs ahead of the door when it is opened and closed. After the foldable sliding door has been retracted into the door compartment, the folding sliding door is therefore suspended on one side, which may cause the foldable sliding door to misalign. When the folding sliding door is retracted into the door compartment, the folded sliding door may therefore contact the top panel or bottom panel of the piece of furniture. Due to manufacturing and mounting tolerances the task of the displacement device of keeping the door or foldable sliding door in vertical alignment in any position within the door compartment may therefore not always be optimally fulfilled.

The present invention is therefore based on the object of creating an improved piece of furniture with an improved displacement device.

With the improved displacement device the one-part or multi-part door shall be advantageously displaceable into a door compartment without contacting the floor or ceiling of the door compartment.

In particular, an improved displacement device shall be created for a piece of furniture that comprises a foldable sliding door with door elements, one of which is held by means of a guide carriage that is slidable along a guide rail that runs along the front of the piece of furniture and into the door compartment.

The displacement device shall occupy little space and allow the mounting profile to be moved over a maximum distance.

The displacement device shall keep the mounting profile with the associated door stable in vertical orientation over the entire displacement range and especially in the end positions. Further, any misalignment that occurs should be correctable in a simple manner and by simple means.

The displacement device shall further allow the mounting profile as well as the door to be mounted in a simple manner.

This problem is solved with a piece of furniture that comprises the features of claim 1. Advantageous embodiments of the invention are defined in further claims.

The piece of furniture comprises a one-part or multi-part door, which serves to close an opening of the piece of furniture and which is connected by hinges to a mounting profile which is held within a door compartment by a displacement device displaceably between a first end position and a second end position,

which displacement device has a lever mechanism comprising four lever units rotatable in a plane, a first connection bridge and a second connection bridge and a centre bridge,

which centre bridge is pivotally connected on a first side by a first lever unit and a second lever unit, which are spaced apart and aligned parallel to one another, each to the first connection bridge, which is connected to at least one holding device mounted on the piece of furniture, and

which centre bridge is pivotally connected on a second side by a third lever unit and a fourth lever unit, which are spaced apart and aligned parallel to one another, each to the second connection bridge, which is connected to the mounting profile.

According to the invention in the first end position of the mounting profile the lever units are aligned at least approximately parallel to the first and second connection bridge and are at least partially sunk into the centre bridge, which centre bridge in this first end position of the mounting profile is at least partially sunk into one of the first and second connection bridges.

The first connection bridge can be connected to the holding device in one piece or detachably, if necessary via an adaptor. The second connection bridge can be connected to the mounting profile in one piece or detachably, if necessary via an adaptor.

Due to the parallel alignment of the parts of the displacement device in the end position, in which the door is fully inserted into the door compartment, and due to the mutual displacement of the parts of the displacement device into one another, only little space is required as a result. The centre bridge and the lever units and preferably also the connection bridges connected thereto can be moved completely or partially into one another, so that they are aligned in parallel with a minimum distance and are almost aligned coaxially. The door can therefore be driven into the door compartment over a maximum distance, therefore allowing the use of doors with a greater width.

The inventive displacement device is particularly advantageous for use in a piece of furniture comprising a foldable sliding door or a door with several door elements, of which one door element is held by a guide carriage which is slidable along a guide rail that comprises a first rail part extending along the front side of the piece of furniture and a second rail part extending inside the door compartment, which first and second rail part are connected to each other by a rail curve.

By means of the inventive displacement device, the door or foldable sliding door can be held vertically aligned in any position within the door compartment.

A misalignment of the door inserted into the door compartment can be easily compensated by a bearing element or corrected by adjusting the lever mechanism.

The displacement device can be changed between a first end position, in which the lever mechanism is fully folded and the door is fully inserted into the door compartment, and a second end position, in which the lever mechanism is fully unfolded and the door is moved out of the door compartment.

In preferred embodiments, the first and second lever units are connected by lever joints to the first connection bridge and to the centre bridge. In this embodiment, the third and fourth lever units are each connected by lever joints on the one hand to the second connection bridge and on the other hand to the centre bridge.

For the adjustment of the displacement device or of the lever mechanism, the distance between the lever joints and thus the distance between the axes of rotation of the lever joints of at least one of the lever units is preferably adjustable. Thereby an adjustment range is provided which allows for correcting maximum possible misalignments.

Preferably the distance of the lever joints and thus the distance of the corresponding rotation axes of the third and the fourth lever unit is adjustable, which form the underside of the lever mechanism and are particularly suitable for the correction of a possible inclination in the end position of the mounting profile with folded lever mechanism.

For changing the distance between two corresponding lever joints at least one of the lever joints is preferably displaceably mounted along the longitudinal axis of the associated lever unit and can be displaced and fixed by means of an adjustment device.

The adjustment device preferably comprises a bearing block mounted in the associated lever unit so as to be displaceable at least approximately along its longitudinal axis. The bearing block, which holds a joint shaft of the associated lever joint, is adjustable by means of an adjustment screw that is held rotatable and axially non-displaceable. The joint shaft determines the axis of rotation, so that the displacement of the bearing block also changes the distance of the axes of rotation of the respective lever unit. In this way the inclination of the held door or foldable sliding door can easily be adjusted, especially in the critical end position of the mounting profile with the lever mechanism folded.

The bearing block preferably has a cross section that is adapted to an internal cross section of the lever unit, which corresponds for example to a U-profile with retaining grooves or to a T-profile. The bearing block is thus held positively and can only be moved along the longitudinal axis of the lever unit. The adjustment screw is preferably aligned axially parallel or coaxial to the longitudinal axis of the lever unit and engages with the screw shaft in a threaded hole of the bearing block and can thus move it axially by turning the adjustment screw. To allow the joint shaft to be moved with the bearing block, appropriate longitudinal openings must be provided in the legs of the e.g. U-profile-shaped lever unit. The longitudinal openings preferably run parallel to the longitudinal axis of the lever unit and thus allow the displacement of the joint shaft and thus the axis of rotation of the lever joint.

The adjustment screw itself is held rotatable but axially not movable by a holding block. The holding block is, for example, clamped within the inner cross section of the lever unit or held in a slot, which, for example, extends perpendicular to the longitudinal axis of the lever unit and is provided therein. The holding block has for example ribs or wings on both sides, which can be inserted into holding grooves running perpendicular to the longitudinal axis of the lever unit. By inserting the adjustment screw and connecting it to the bearing block, which can only be moved axially, the holding block is thus also fixed in the receiving position.

The first and second lever units are rotatably held by the centre bridge and must therefore, before they can be connected to the mounting profile, be brought into a corresponding alignment, which is a mirror image of the alignment of the third and fourth lever unit. This connection is made in the second end position of the shifting device with an unfolded part of the lever unit which comprises the third and fourth lever unit which are already connected to the holding device or holding devices. The first and second lever units are not yet connected and are thus turned by gravitational force downwards against the floor of the door compartment. It is therefore an object to facilitate the precise connection of the lever mechanism to the mounting profile and especially to avoid multiple readjustments.

In order that the installer does not have to determine the alignment himself, a balancing device is preferably provided which ensures that the first and second lever units are always aligned symmetrically to the third and fourth lever unit. The balancing device comprises two balancing levers connected by a sliding joint to one another, the ends of which are each connected to an associated lever unit in such a way that they form a four-bar linkage. The two balancing levers are connected with lever units of the lever mechanism lying at the same level, i.e. with the first and third lever unit and/or the second and fourth lever unit. The balancing unit can therefore be designed in one or two parts. The diagonally opposite lever joints of the resulting four-bar linkage form pairs of joints that behave in opposite ways. If one pair of joints approaches, the distance of the other pair of joints increases and vice versa. The sliding joint is slidably guided and held in a guide track of the centre bridge and moves back and forth when the four-bar linkage is changed.

In this way it is ensured that the first and second lever units of the lever mechanism are always kept at the same level. The first and second lever units intended for connection to the mounting profile and the first connection bridge are therefore held in the second end position of the lever mechanism in a position where they can be connected to the mounting profile. It is therefore not necessary to manually hold the first and second lever units and the first connection bridge in a suitable position and make corrections if required.

It should be noted that the invention thus comprises different solutions which can also be implemented independently of each other, but which complement each other ideally. The adjustability of the distances of the axis of rotation of the lever mechanism by at least one adjustment device can be provided independently of the use of a one-piece or two-piece balancing device. Conversely, the balancing device can be used independently of the adjustability of the distances of the axis of rotation of the lever mechanism. Overall, however, when implementing all solutions the installation effort is considerably reduced. Incorrect settings and undesired misalignment of the door or the foldable sliding door as well as correspondingly complex corrective measures are no longer necessary.

Preferably in the piece of furniture or connected to the displacement device, damping elements are used which act directly or indirectly on the door, gently gripping it and accompanying it into the end position.

In preferred embodiments, the third and fourth lever units, which face the at least one holding device connected to the piece of furniture, each comprise two preferably plate-shaped lever elements, which are arranged at a distance from and preferably parallel to each other. Preferably also the first and second lever units facing the mounting profile each comprise two preferably plate-shaped lever elements, which are arranged spaced apart from each other and preferably parallel to each other. The lever units, however, are preferably designed as one piece.

The centre bridge preferably has an L-profile, an H-profile or a U-profile with a profile space limited by profile parts into which the associated first and/or second and/or third and/or fourth lever unit can be sunk.

Preferably, the third and fourth lever unit facing the at least one holding device connected to the piece of furniture or the first and second lever unit facing the mounting profile can be turned or shifted into the centre bridge.

In another preferred design, the first and second lever unit or the third and fourth lever unit are rotatably mounted on the outside of the centre bridge.

The lever units can therefore be aligned in parallel either inside or outside the centre bridge so that only a minimum of space is required. The lever units can be partially or preferably completely sunk into the centre bridge.

In a further preferred embodiment, the first or the second bar-shaped connection bridge will each have an L-profile or a U-profile, which has a profile space limited by profile parts or a neighbouring profile space into which parts of the lever mechanism can be inserted or turned. The profile spaces of the connection bridges can be identically or differently dimensioned. The connection bridges can preferably accommodate corresponding parts of the lever unit and of the centre bridge. If the profile spaces are differently dimensioned, it can be provided that one of the connection bridges not only takes up the lever units and the centre bridge, but also the other connection bridge completely or partially.

The lever units rotate downwards or upwards together when the lever mechanism is operated. The direction of movement is chosen taking into account whether the weight of the lever mechanism should support the insertion or extraction of the door.

Below, the invention is explained with reference to the drawings. Thereby shows:

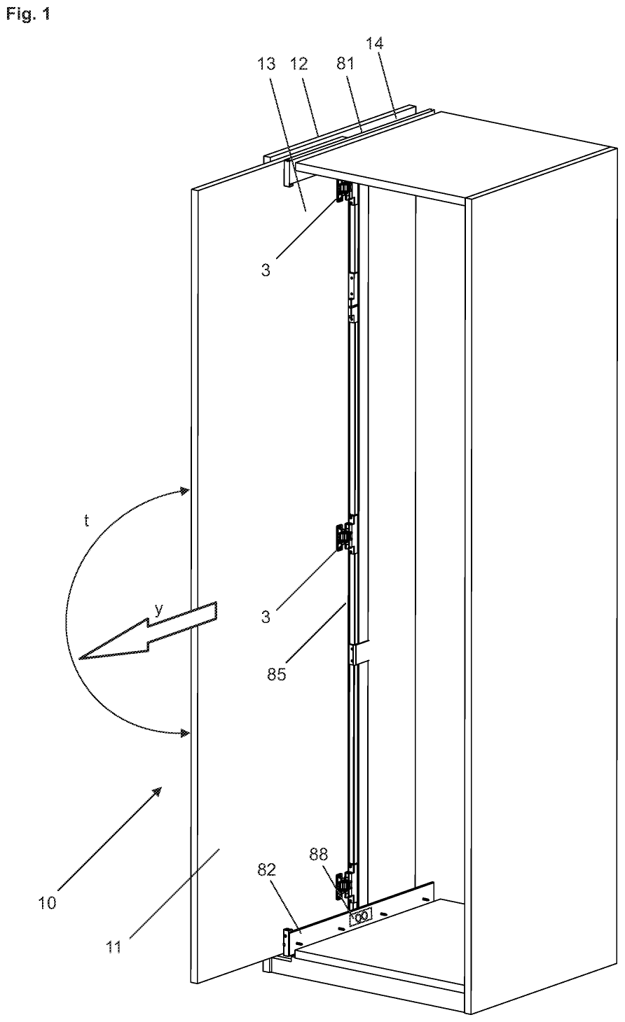

FIG. 1 a piece of furniture 10 with a door 11 held by a mounting profile 85 prior to mounting an inventive displacement device 1;

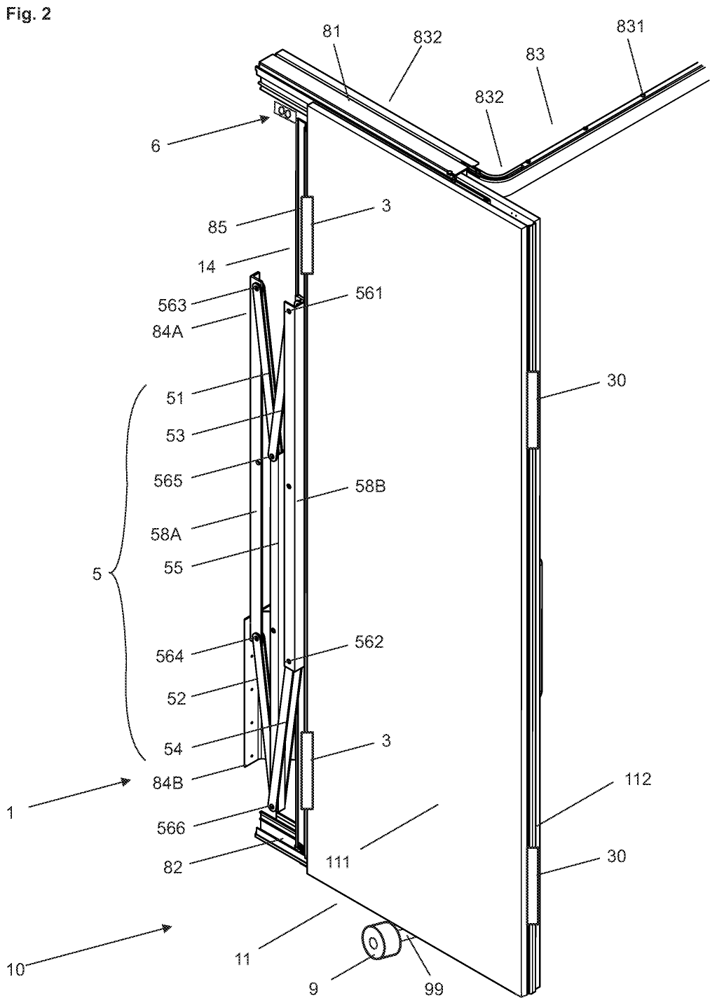

FIG. 2 a piece of furniture 10 with an inventive displacement device 1, which has a lever mechanism 5 with four lever units 51, 52, 53, 54, which is connected on the one hand to holding devices 84A, 84B and on the other hand to a mounting profile 85, on which a door 11 with two door elements 111, 112 is mounted by hinges 3;

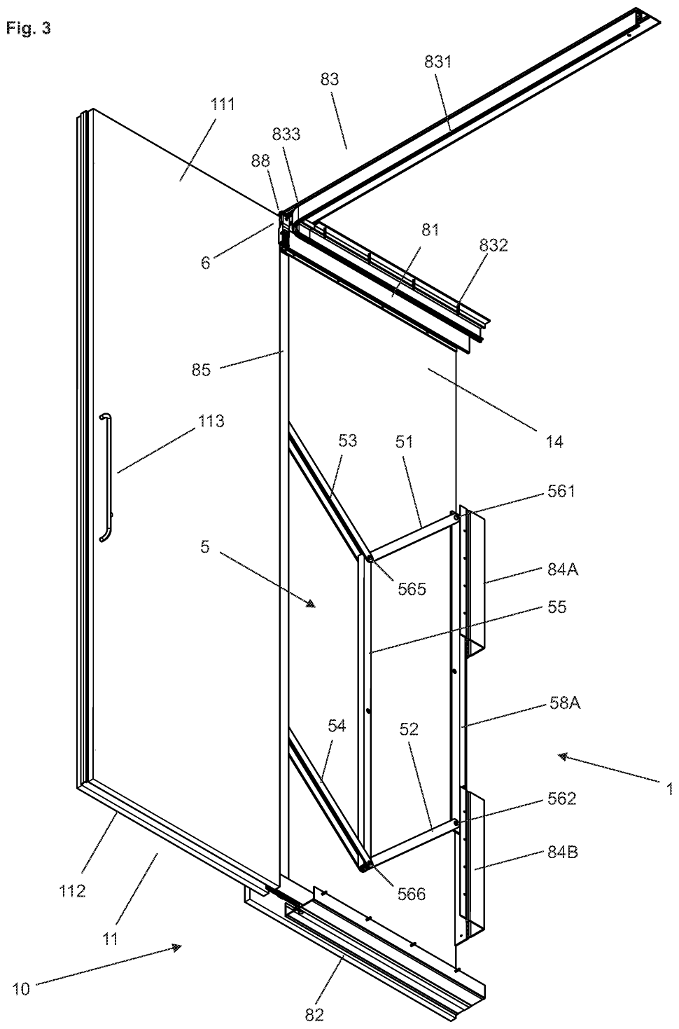

FIG. 3 the piece of furniture 10 of FIG. 2 with extracted door elements 111, 112, of which the first door element 111 is hinged on one side to the mounting profile 85 and on the other side to the second door element 112, which is held at the front by means of a guide carriage 6 displaceable along a guide rail 83;

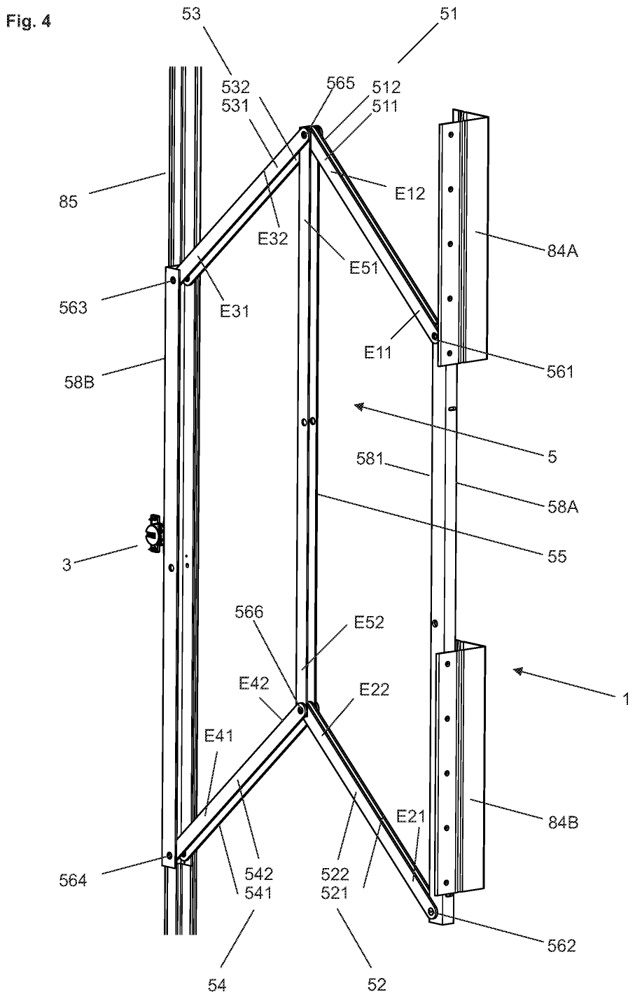

FIG. 4 the displacement device 1 of FIG. 2 and FIG. 3 with the inversely mounted lever mechanism 5 with the first and second lever units 51, 52 connected to the holding devices 84A, 84B and with the third and fourth lever units 53, 54 connected to the mounting profile 85;

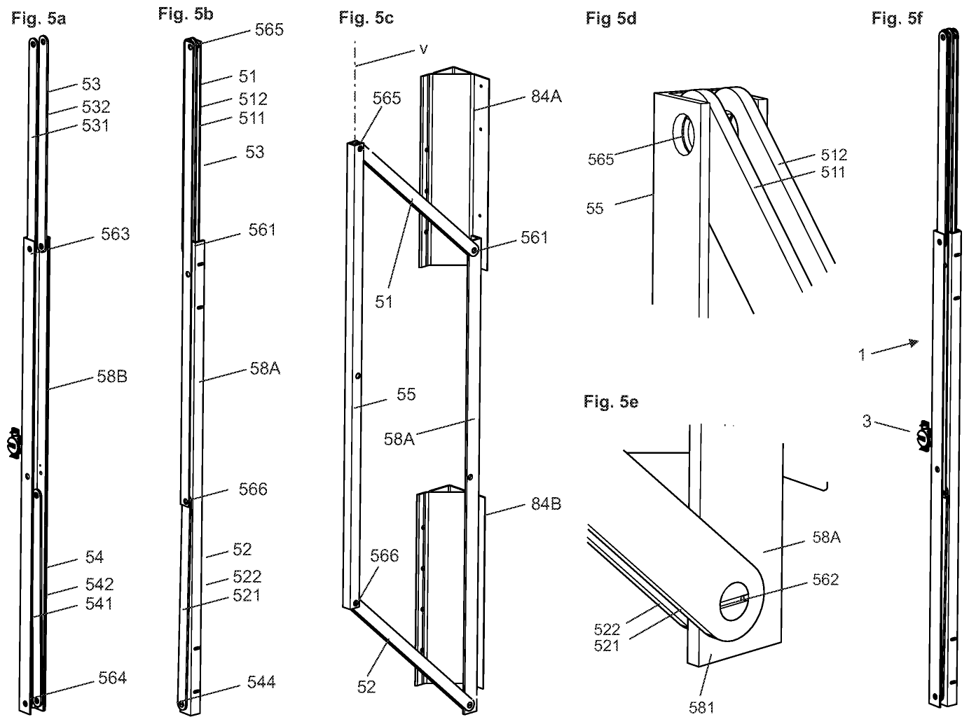

FIG. 5a the third and fourth lever units 53 and 54 of the lever mechanism 5 of FIG. 2, connected to the second connecting bridge 58B and axially aligned thereto;

FIG. 5b the first and second lever units 51, 52 of the lever mechanism 5 of FIG. 2, axially aligned and connected to the first connecting bridge 58A and to the centre bridge 55;

FIG. 5c the first and second lever units 51, 52 axially aligned and connected to the first connecting bridge 58A and the centre bridge 55, with the lever mechanism 5 partially open;

FIG. 5d a detailed view of the upper part of the centre bridge 552 and the lever elements 511, 512 of FIG. 5c, which are connected to each other by the upper centre lever joint 563;

FIG. 5e a detailed view of the lower part of the first connecting bridge 58A and the lever elements 521, 522 of FIG. 5c connected by the lever joint 564 to a profile blade 581;

FIG. 5f the completely folded displacement device 1 of FIG. 2;

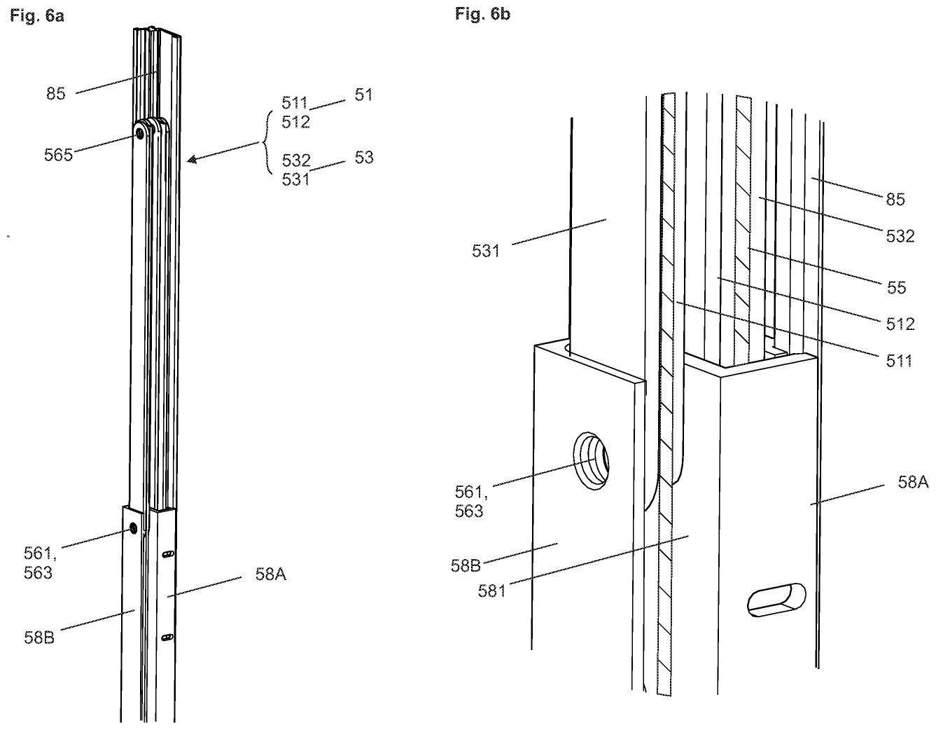

FIG. 6a the upper end of the displacement device 1 of FIG. 5f;

FIG. 6b a detailed view of the displacement device 1 of FIG. 6a;

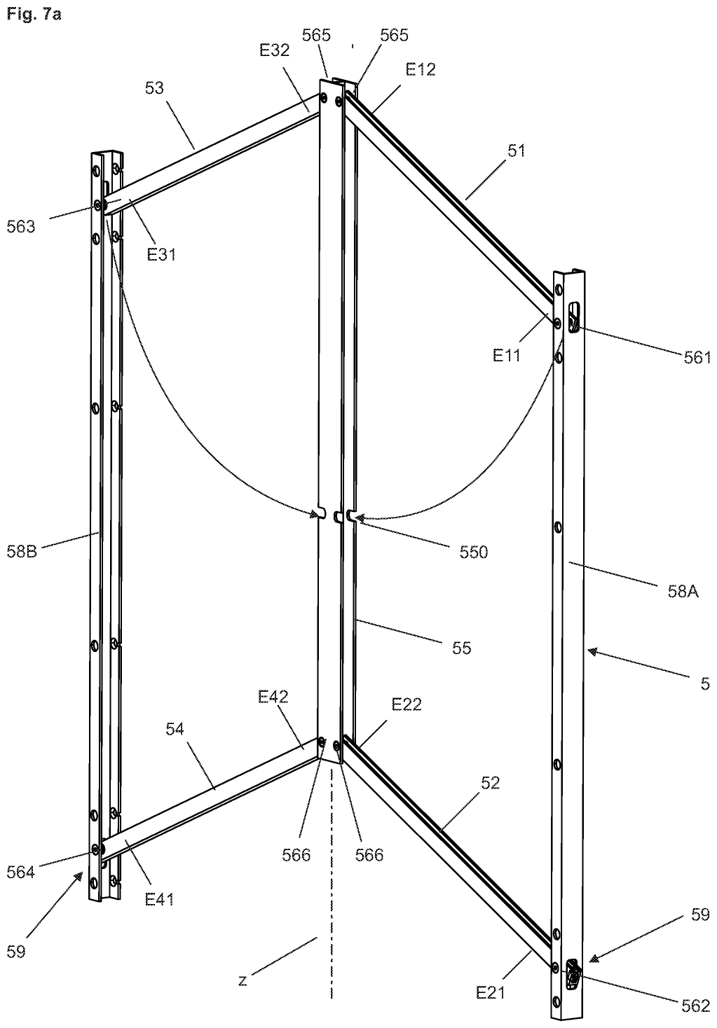

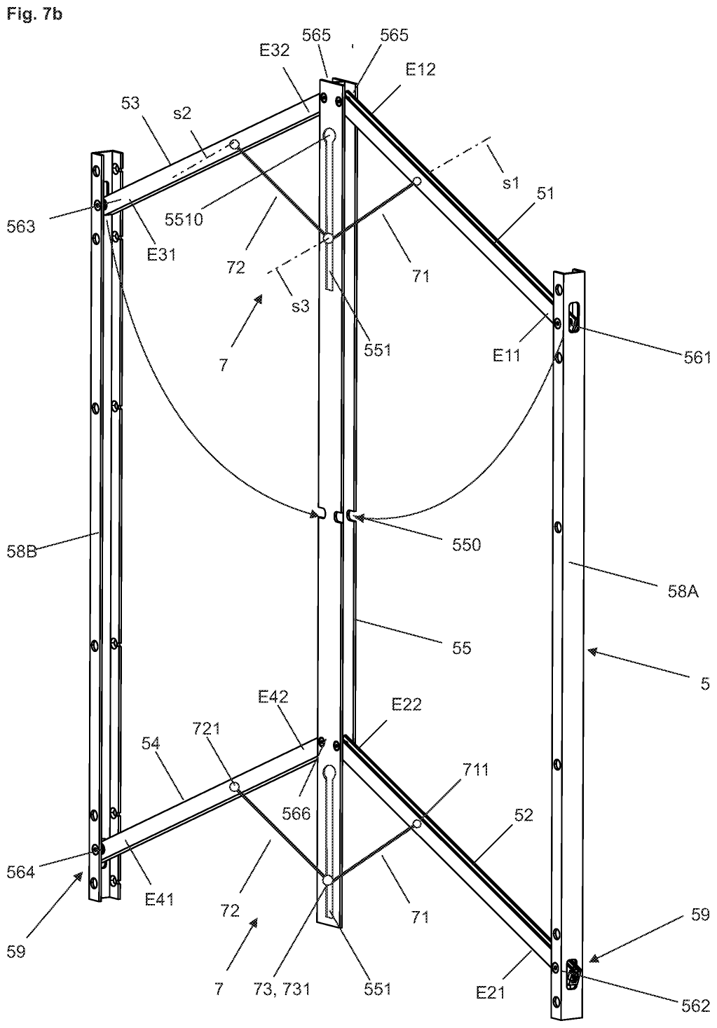

FIG. 7a the lever mechanism 5 of FIG. 4 in a preferred embodiment;

FIG. 7b the lever mechanism 5 of FIG. 7a supplemented with two balancing devices 7;

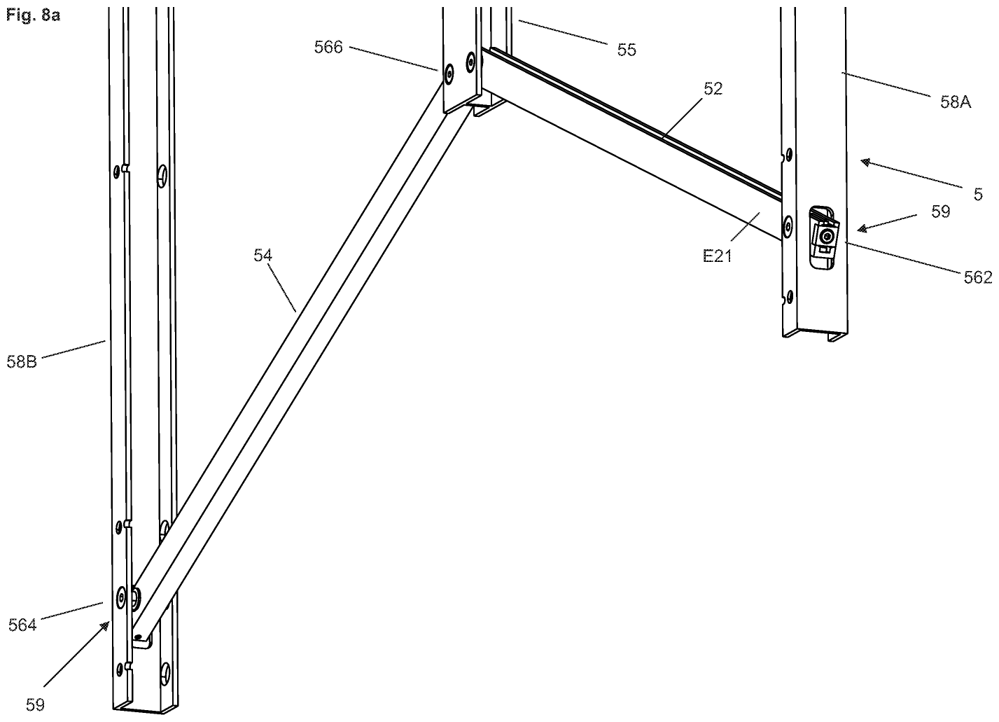

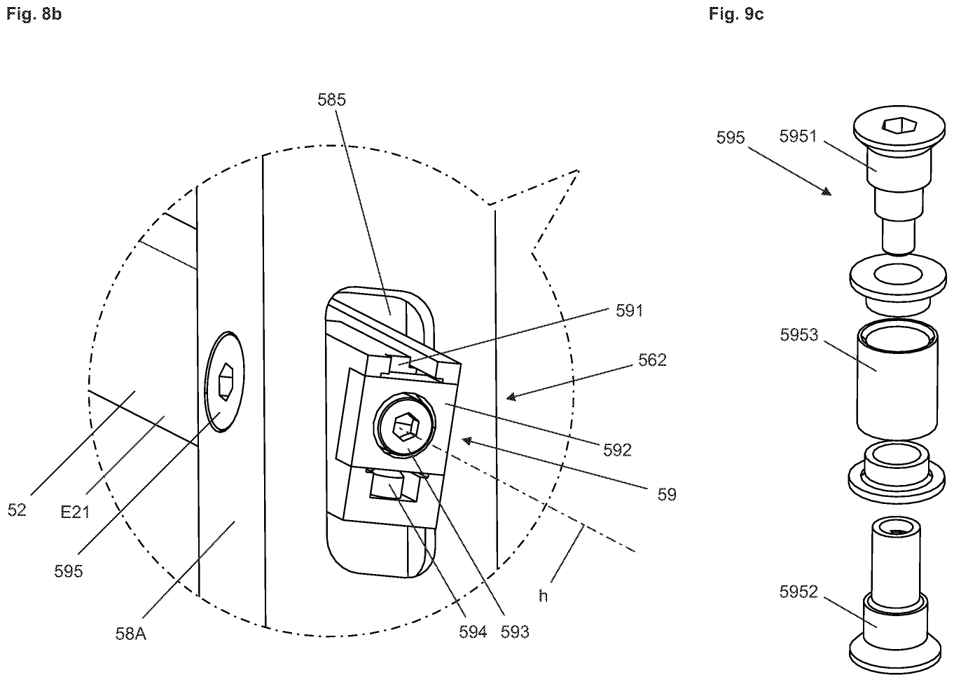

FIG. 8a the lower part of the lever mechanism 5 of FIG. 7a with second and fourth lever units 52 and 54, each equipped with an adjustment device 59;

FIG. 8b in enlarged view the second lever unit 52 of FIG. 8a with the adjustment device 59;

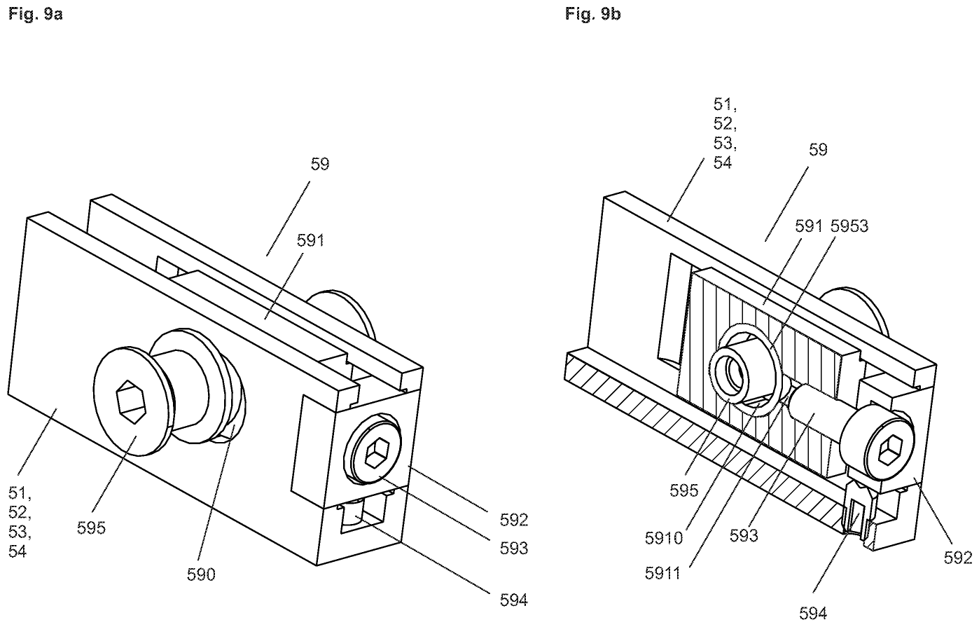

FIG. 9a a part of one of the lever units 51, 52, 53, 54 with an inserted adjustment device 59, which comprises a displaceable and adjustable bearing block 591, by which a joint shaft 595 of an associated lever joint is held;

FIG. 9b the adjustment device 59 of FIG. 9a in a longitudinal section;

FIG. 9c the multi-part joint shaft 595 of FIG. 9a;

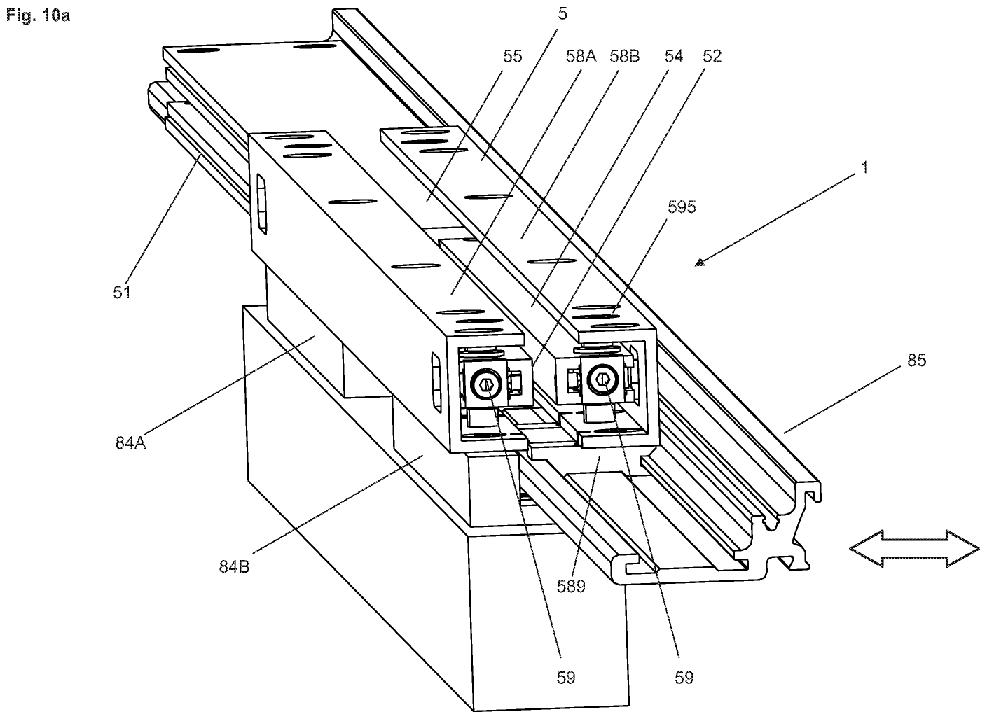

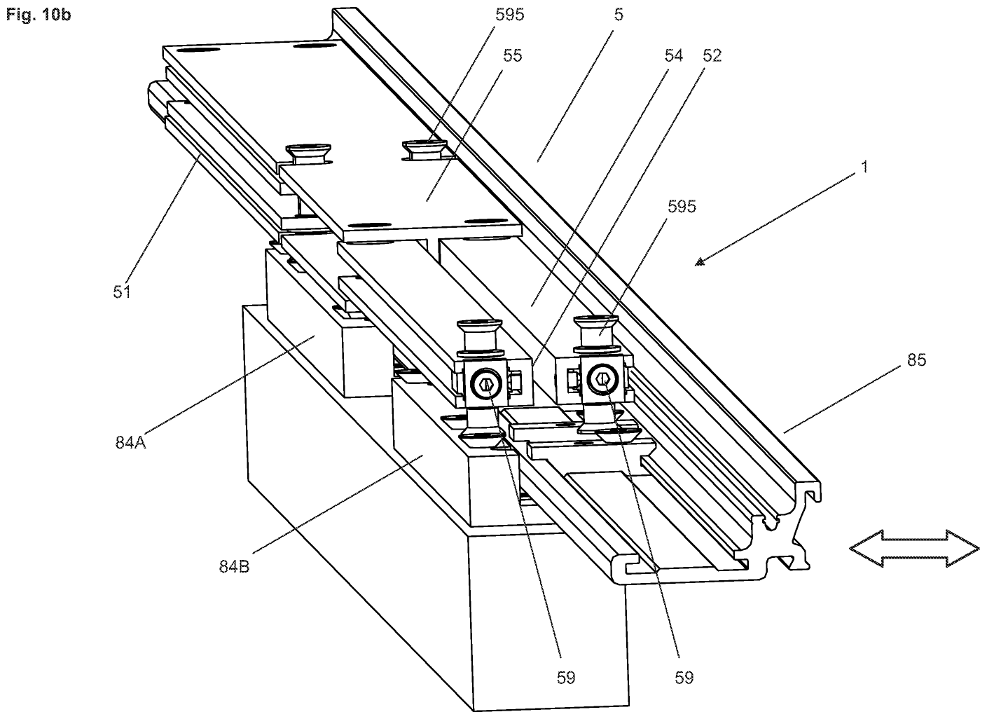

FIG. 10a a displacement device 1 with the folded lever mechanism of FIG. 7a; and

FIG. 10b the displacement device 1 of FIG. 10a without the connection bridges 58A, 58B.

FIG. 1 shows a piece of furniture 10 with a door 11 held by a mounting profile 85 prior to the installation of a displacement device 1. About half of the door 11 has been driven into a door compartment 14, which is delimited by an outer wall 12 and a partition wall (removed) of the piece of furniture 10. The mounting profile 85 is pivotally connected to the door 11 with three hinges 3, so that the door 11 can be pulled out of the door compartment 14 and rotated to cover an opening of the piece of furniture 10.

The mounting profile 85 is guided within the door compartment 14 along a displacement axis y by means of support carriages 88 (symbolically shown) attached to an upper and a lower holding rail 81, 82. The holding rails 81, 82 absorb the weight of the door 11. However, tilting moments t of the door 11, which cause it to tilt, cannot be compensated by the holding rails 81, 82 and running gear. The mounting profile 85 is therefore connected in a further mounting step to a displacement device 1 as shown in FIG. 2 or in FIG. 7a. By means of the displacement device 1, the mounting profile 85 and thus the door 11 is always precisely held in vertical alignment over the entire displacement range. Any misalignments can be easily corrected. The displacement device 1 can also be mounted easily and precisely by using a balancing device 7 (see FIG. 7b).

FIG. 2 shows parts of the piece of furniture of FIG. 1 with a two-part door or foldable sliding door 11 with a first door element 111, which is guided with the mounting profile 85 along the holding rails 81, 82 and connected by hinges 30 to a second door element 112. The second door element 112, which is retracted into the door compartment 114 at the front, is connected at the front to a guide carriage 6 (symbolically shown), which is guided in a guide rail 83. The guide rail 83 has a first rail section 831 extending parallel to the front of the piece of furniture 10 and a second rail section 832 extending into the door compartment 14. The two rail sections 831, 832 are connected by a curved section 833. The guide carriage 6 can therefore run over the entire area of the guide rail 83. After extending and unfolding the foldable sliding door 11, the drive 6 moves with the front side of the second door element 112 in front.

The piece of furniture 10 is now equipped with a displacement device 1, which includes a lever mechanism 5.

In FIG. 2 the foldable sliding door 11 is almost completely retracted into the door compartment 14 and is only held on one side by the displacement device 1 and by the drives guided along tracks 81, 82 and the guide rail 83. The door 11 therefore has a strong tendency to tilt forward. Hence, if the displacement device 1 is not adjusted optimally, a misalignment of the door 11 results.

In a preferred embodiment, for the compensation of this inclination, a bearing element 9 is provided in the area of the front end of the door compartment 14, on which the first and/or the second door element 111, 112 can be supported when present. Preferably the door elements 111, 112 are released from the bearing element 9 before they are turned in front of the opening of the piece of furniture 10. A bearing element can be a bearing roller 9 for example, which is held by a bearing axle 99. Preferably, several bearing elements are provided so that the load is divided. It is also possible to combine different bearing elements, e.g. the combination of a roller bearing and a plain bearing.

In a preferred embodiment, however, the misalignment is corrected by an adjustment or setting of the lever mechanism 5, as described below.

The lever mechanism 5 comprises first and second lever units 51, 52, which on one side are hinged together by a rod-shaped centre bridge 55 and on the other side by a first connection bridge 58A, as well as third and fourth lever units 53, 54, which are hinged together on one side by the centre bridge 55 and on the other side by a second connection bridge 58B.

At the connection points of the resulting joint polygon, lever joints 561, 562, 563, 564, 565, 566 are provided which allow the mutual rotation of the connected elements. At the centre bridge 55 the two lever joints 565, 566 are provided, which are each connected with two lever units 51, 53 or 52, 54. Alternatively, a lever joint 565, 566 can be provided on the centre bridge 55 for each of the lever units 51, 53 or 52, 54.

The first connection bridge 58A is connected in one piece or detachably to holding devices 84A, 84B, which are firmly mounted on the back, e.g. on the back wall or a sidewall of the piece of furniture 10. The second connection bridge 58B is connected in one piece or detachably to the mounting profile 85, which is connected via hinges 3 to the foldable sliding door 11.

The lever mechanism 5 shown in FIG. 4 forms two mirror-symmetrical parallelograms which perform the same movements during the retraction and extraction of door 11. The lever units 51, 53, 52, 54 each have a first end piece E11; E31; E31; E41 and a second end piece E12; E32; E32; E42.

When inserting the door 11, the parts of the lever mechanism 5, especially the lower and upper lever units 53, 54; 52, 54, are inserted into one another and aligned parallel to one another. In some preferred designs, the lever units 53, 54; 52, 54 and the connection bridges 58A, 58B are inserted into one another. In a preferred embodiment, the parts of the lever mechanism 5 can also be shifted parallel to each other into the mounting profile 85, thus minimizing the space requirement.

FIG. 3 shows the piece of furniture 10 of FIG. 2 with extracted but not yet unfolded door elements 111, 112, of which the first door element 111 is hinged on one side to the mounting profile 85 and on the other side to the second door element 112, which is slidable along the guide rail 83 by means of the guide carriage 6. The door 11 was gripped by a handle 112 and pulled out of the door compartment 114. During this procedure the lever units 51, 52, 53, 54 and the centre bridge 55 were lifted. Additional force was therefore required to pull out the door elements 111, 112. The insertion of the door elements 111, 112 is now supported by the weight of the lever elements 51, 52, 53, 54 and the centre bridge 55. If, however, the extension of the door elements 111, 112 is to be supported by the weight of the lever elements 51, 52, 53, 54 and of the centre bridge 55, the lever mechanism 5 is inverted as shown in FIG. 4.

FIG. 4 shows the displacement device 1 of FIG. 2 and FIG. 3 with inverted orientation of the lever mechanism 5 in a larger view, showing the design of the parts of the lever mechanism.

It is shown that the lever units 51, 53; 52, 54 each have two plate-shaped lever elements 511, 512; 531, 532; 521, 522; 541, 542, which are held at an allocated distance from each other by the first and second peripheral upper lever joints 561, 563; the first and second peripheral lower lever joints 562, 564 and the upper and lower centre lever joint 565, 566.

The U-profiled centre bridge 55 has two legs that are open in the direction of the holding devices 84A, 84B and in the direction of the first connecting bridge 58A. The first connecting bridge 58A, on the other hand, has a profile blade 581, which is directed towards the centre bridge 55 and can enter between the legs of the centre bridge 55. The profile blade 581 preferably has recesses into which joint shafts can enter.

The second connection bridge 58B, which is connected to the centre bridge 55 by the third and fourth lever units 53, 54, has a U-profile that is open towards the centre bridge 55 and can accommodate the entire folded lever mechanism 5.

The distance between the plate-shaped lever elements 511, 512; 521, 522 of the first and second lever units 51, 52 connecting the centre bridge 55 and the first connection bridge 58A is less than the distance between the side plates of the U-profile of the centre bridge 55 but greater than the width of the profile blade 581. The plate-shaped lever elements 511, 512; 521, 522 held inside the U-profile of the centre bridge 55 can therefore be shifted into the U-profile of the centre bridge 55 and at the same time also hold the profile blade 581 of the first connection bridge 58A as shown in FIG. 5b.

The distance between the plate-shaped lever elements 531, 532; 541, 542 of the third and fourth lever units 53, 54 facing the mounting profile 85 is greater than the width of the U-profile of the centre bridge 55, so that the lever elements 531, 532; 541, 542 mounted on the outside of the centre bridge 55 can accommodate the centre bridge 55 in between.

At the same time the distance between the plate-shaped lever elements 531, 532; 541, 542 of the third and fourth lever units 53, 54 is smaller than the width of the second connection bridge 58B, so that they can be turned downwards or upwards into the U-shaped second connection bridge 58B, as shown in FIG. 5a. With the plate-shaped lever elements 531, 532; 541, 542 of the third and fourth lever units 53, 54, the lever pack of FIG. 5b held in between can be turned into the U-shaped second connection bridge 58B. During this procedure the first connection bridge 58A is also inserted into the second connection bridge 58B.

FIG. 5a shows the third and fourth lever units 53 and 54 of the lever mechanism 5 of FIG. 4, which are connected to the U-shaped second connection bridge 58B and axially aligned with it.

FIG. 5b shows the axially aligned first and second lever units 51, 52 of the lever mechanism 5 of FIG. 4 connected to the first connection bridge 58A and the centre bridge 55.

FIG. 5c shows the first and second lever units 51, 52 connected on one side to the first connection bridge 58A and on the other side to the centre bridge 55 and axially aligned thereto with the lever mechanism 5 partially open.

FIG. 5d shows a detailed view of the upper part of the centre bridge 552 and the lever elements 511, 512 of FIG. 5c, which are connected by the upper centre lever joint 563;

FIG. 5e shows a detail of the lower part of the first connection bridge 58A and the lever units 521, 522 of FIG. 5c connected to the profile blade 581 through the first peripheral lower lever joint 564.

FIG. 5f shows the fully folded displacement device 1 of FIG. 4.

FIG. 6a shows the upper end of the fully folded displacement device 1 of FIG. 5f. It can be seen that practically the entire lever mechanism is accommodated by the mounting profile 85 and therefore practically no additional space is required for the lever mechanism 5.

FIG. 6b shows a detailed view of the displacement device 1 of FIG. 6a. It is shown that in the second connection bridge 58B held by the mounting profile 85, the lever elements 531, 532 of the lever unit 53 and between them the centre bridge 55 are inserted, in which the lever elements 511, 512 of the lever unit 51 and between them the profile blade 581 of the first connection bridge 58A are inserted.

FIG. 7a shows the lever mechanism 5 of FIG. 4 in a preferred embodiment with U-shaped connection bridges 58A, 58B and an H-shaped centre bridge 55 as well as with one-piece lever units 51, 52, 53, 54, each of which preferably having a U-shaped cross-section suitable for accommodating an adjustment device 59. Adjustment devices 59 can be provided at all end pieces of all lever units 51, 52, 53, 54. The lever mechanism 5 can be adjusted particularly advantageously if an adjustment device 59 is provided at the end piece E21, E41 of the second lever unit 52 and/or the fourth lever unit 54 connected to the corresponding connection bridge 58A, 58B. By operating the adjustment device 59, the lever axes of the corresponding lever unit 52 or 54 can be shifted against each other. The adjustment devices 59 are preferably adjusted in the folded state of the lever mechanism 5 to correct misalignment of the door or foldable sliding door 11. The folded lever mechanism 5 with a view to the adjustment screws 59 is shown in FIG. 10a.

FIG. 7a also shows that the first and second lever unit 51, 52 can be inserted from one side and the third and fourth lever unit 53, 54 from the other side into the H-profile of the centre bridge 55. In this procedure the first and second lever units 51, 52 and part of the centre bridge 55 are inserted into the first connection bridge 58A and the third and fourth lever units 53, 54 and part of the centre bridge 55 are inserted into the second connection bridge 58B. The joint shafts of the lever joints 561, 563, which connect the first lever unit 51 with the first connection bridge 58A and the third lever unit 53 with the second connection bridge 58B, are inserted into receiving openings 550 provided in the centre bridge 55.

The folded displacement device 1 with the folded lever mechanism 5 of FIG. 7a is almost completely accommodated by the mounting profile 85 and takes up very little space.

FIG. 7b shows the lever mechanism 5 of FIG. 7a supplemented with two balancing devices 7. Since all parts of the lever mechanism 5 are coupled together, it would be sufficient to provide only one balancing device 7 for example to connect the second and fourth lever unit 52, 54. If, on the other hand, the balancing devices 7 are to take up larger loads, two of them may be used.

Each balancing device 7 forms a 3-point pivotal connection with the lever mechanism 5. Two points are connected to corresponding or mirror-symmetrical lever units 51, 53 or 52, 54. The third point can be moved along the centre bridge 55.

Each balancing device 7 comprises two balancing levers 71, 72, which are connected to one another by a sliding joint 73 and which are connected each to the corresponding lever unit 51, 53 or 52, 54 by joints 711, 721. The joints may be soft like the lever joints of the lever mechanism and typically comprise a joint shaft which pierces the corresponding levers or their end pieces. The sliding joint 73 is mounted in a guide track 551 of the centre bridge 55. The corresponding lever units 51, 53 and 52, 54 are therefore always held by the balancing device 7 in a mirror-symmetrical position, i.e. with the same inclination to the centre bridge 55. The second connection bridge 58B can therefore easily be connected to the mounting profile 85 of FIG. 1. Corrections are either unnecessary or reduced to a minimum. The sliding joint 75, for example, comprises a wheel with a circular wheel groove, which is limited by wheel flanges. The wheel is pierced centrally by a joint shaft which holds the facing ends of the balancing lever 71, 72.

The balancing device 7 comprises two balancing levers 71, 72 which are connected to each other, on one side, rotatably by a sliding joint 73 and, on the other side, by joints 711, 721, either to the first and third lever units 51, 53 or to the second and fourth lever units 52 or 54. The joints may be of the same design as the lever joints of the lever mechanism and typically comprise a cardan shaft which passes through the corresponding levers or their end pieces. The sliding joint 73 is slidably mounted in a guide track 551 of the centre bar 55. The corresponding lever units 51, 53 or 52, 54 are therefore always kept mirror-symmetrical by the balancing device 7, i.e. with the same inclination to the centre bridge 55. The second connecting bridge 58B can therefore easily be connected with the mounting profile 85 of FIG. 1. Corrections are not necessary or are reduced to a minimum. The sliding joint 75 includes, for example, a wheel with a circular wheel groove, which is limited by wheel flanges. The wheel is passed centrally through by a joint shaft which holds the facing ends of the balancing levers 71, 72.

FIG. 7b shows that guide track 551 has an inlet opening 5510, into which the sliding joint 73 is inserted in such a way that the edges of the guide track 551 adjacent to the inlet opening 5510 can engage in the wheel groove as guide flanges. The sliding joint 73 is thus held in guide track 551 and can only be moved axially along this guide track 551 or axially along the longitudinal axis x of the centre bridge 55 (see FIG. 7a). When turning the corresponding lever units 51, 53 or 52, 54, the balancing levers 71, 72 turn around the resulting balancing axes or joint axes s1, s2, s3 of the joints 711, 721, 731.

Already with the installation of one balancing device 7, all parts of the lever mechanism 5 are positively guided, which is why the first and second lever units 51, 52 are guided mirror-symmetrically to the third and fourth lever unit 53, 54, even if they are not yet guided by the holding rails 81, 82. The precise positioning of the lever mechanism 5 for connection with the mounting profile 85 of FIG. 1 will therefore take place automatically.

FIG. 8a shows the lower part of the lever mechanism 5 of FIG. 7a with the second and fourth lever units 52 and 54, each equipped with an adjustment device 59. It can be seen that the first and second connection bridge 58A, 58B each have a U-profile, which are open towards each other. The centre bridge 55 has an H-profile into which the second and fourth lever units 52, 54 can enter. The centre bridge 55 can enter the U-profile of the facing connection bridge 84A or 84B on both sides. Please note that there is space between the legs of the U-profiles of the connection bridges 84A, 84B and the lever units 52, 54 in which the side plates of the H-profile of the centre bridge 55 can enter.

FIG. 8b shows an enlarged view of the second lever unit 52 of FIG. 8a with the adjustment device 59 provided at its end piece E21. The end piece E21 of the second lever unit 52 passes partially through an opening 585 in the first connection bridge 58A, so that the adjustment device 59 is easily accessible for adjustment purposes.

The adjustment device 59 comprises a bearing block 591 which is mounted in the lever unit 52 so as to be displaceable along its longitudinal axis. The bearing block 591, which holds a joint shaft 595 of the associated lever joint 562, can be adjusted by means of an adjustment screw 593 which is held rotatable and axially not displaceable. By turning the adjustment screw 593 the bearing block 591 can therefore be moved along the longitudinal axis h of the lever unit 52. The joint shaft 595 determines the position of the axis of rotation. Hence, by moving the bearing block 591 also the distance of the axes of rotation of the respective lever unit 562 changes accordingly. In this way, the inclination of the held door or folding-sliding door 11 can easily be adjusted, especially in the critical end position of the assembly profile 85 with the lever mechanism 5 folded.

FIG. 9a shows a part of one of the lever units 51, 52, 53, 54 with an inserted adjustment device 59, which comprises the displaceable and adjustable bearing block 591, by which the joint shaft 595 of the corresponding lever joint 562 is held.

FIG. 9b shows the adjustment device 59 of FIG. 9a in a longitudinal section. The reference numbers 51, 52, 53, 54 indicate that the adjustment device 59 can be mounted on each end of each lever unit 51, 52, 53, 54. Preferably only one or two adjustment devices 59 are mounted. However, any number of adjustment devices 59 can be mounted. In principle, the joint shafts of the lever joints can also be shifted and adjusted against each other in other ways. For example, the lever unit 52 can be constructed in two parts and have overlapping elements which can be moved against each other and fixed in any position. Furthermore, the lever unit 52 can have two parts which are provided with threaded elements and connected to each other by a threaded rod. By turning the threaded rod the distance between the lever axes can also be changed. However, the use of the present compact and easily accessible adjustment device 59 is particularly advantageous.

The bearing block 591 of the adjustment device 59 has a cross section adapted to the internal cross section of the lever unit 52, which has a U-profile with legs and leg feet directed towards each other. The bearing block 591 is thus held positively and can only be moved along the longitudinal axis h of the lever unit 52. The adjustment screw 593 is coaxially aligned with the longitudinal axis of the lever unit 52 and engages with the screw shaft in a screw channel 5911 of the bearing block 591 and can move it axially by turning the adjustment screw 593. In order that the joint shaft 595, which is held in a bearing channel 5910 of the bearing block 591, can now be moved with the bearing block 591, corresponding longitudinal openings 95 are provided in the legs of the U-shaped lever unit 52. The longitudinal openings 590 run parallel to the longitudinal axis h of the lever unit 52 and thus allow the displacement of the joint shaft 595 and thus of the axis of rotation of the lever joint 562.

The adjustment screw 593 is held rotatable but axially not movable by a holding block 592. The holding block 592 is clamped within the inner cross section of the lever unit 52 by means of a grub screw 594.

FIG. 9c shows the multi-part joint shaft 595 of FIG. 9a, which has a joint shaft screw 5951 and a joint shaft nut 5952, which when screwed together form the joint shaft 595, on which a swivel bushing 5953 is rotatably mounted. The bearing block 591 is held by the swivel bushing 5953 and can therefore rotate around the joint shaft 595 with virtually no friction.

FIG. 10a shows the displacement device 1 with the folded lever mechanism 5 of FIG. 7a and FIG. 10b shows the displacement device 1 of FIG. 10a without the connection bridges 58A, 58B. The first connection bridge 58A is connected to the holding devices 84A, 84B, which are mounted or mountable on the sidewall or rear wall of the piece of furniture 10 of FIG. 1. The second connection bridge 58B is connected to the mounting profile 85 by an adaptor 589. The mounting profile 85 can be moved along the adaptor 589 and can be fixed for example by a screw.

### LIST OF REFERENCES

1 displacement device
10, 10′ piece of furniture, wardrobe
11 door, particularly foldable sliding door
111 first door element
112 second door element
113 handle
12 sidewall
13 partition wall
14 door compartment
3 hinges
5 lever mechanism
51 first lever unit
511, 512 lever elements of the first lever unit
E11, E12 end pieces of the first lever unit
52 second lever unit
521, 522 lever elements of the second lever unit
E21, E22 end pieces of the second lever unit
53 third lever unit
531, 532 lever elements of the third lever unit
E31, E32 end pieces of the third lever unit
54 fourth lever unit
541, 542 lever elements of the fourth lever unit
E41, E42 end pieces of the fourth lever unit
55 centre bridge
550 receiving openings for the lever joints 561, 563
551 guide track in the end piece 559
5510 inlet opening
E51, E52 end pieces of the centre bridge
561, 562 first and second upper peripheral lever joint
563 upper centre lever joint
564, 565 first and second lower peripheral lever joint
566 lower centre lever joint
58A first connection bridge
58B second connection bridge
581 profile blade
585 window openings in the connection bridges 58A/B
589 adaptor
59 adjustment device
590 bearing window
591 bearing block
5910 bearing channel
5911 screw channel
592 holding block
593 adjustment screw
594 locking screw
595 joint shaft
5951 joint shaft screw
5952 joint shaft nut
5953 swivel bushing
6 guide carriage
7 balancing device
71 first balancing lever
72 second balancing lever
75 sliding joint
81 lower holding rail
82 upper holding rail
83 guide rail
84 holding device
84A first holding device
84B second holding device
85 mounting profile
88 support carriages in the holding rails 81, 82
9 bearing element, bearing roller, plain bearing
99 bearing axle for the bearing element
s1,s2,s3 balancing axes
z longitudinal axis of the centre bridge 55

1. Piece of furniture with a one-part or multi-part door, which serves to close an opening of the piece of furniture and which is connected by hinges to a mounting profile which mounting profile is held within a door compartment by a displacement device displaceably between a first end position and a second end position,
which displacement device has a lever mechanism comprising four lever units rotatable in a plane, a first connection bridge and a second connection bridge and a centre bridge,
which centre bridge is pivotally connected on a first side by a first lever unit and a second lever unit, which are spaced apart and aligned parallel to one another, each to the first connection bridge, which is connected to at least one holding device mounted on the piece of furniture, and
which centre bridge is pivotally connected on a second side by a third lever unit and a fourth lever unit, which are spaced apart and aligned parallel to one another, each to the second connection bridge, which is connected to the mounting profile,
wherein in the first end position of the mounting profile the lever units are aligned at least approximately parallel to the first and second connection bridge and are at least partially sunk into the centre bridge, which centre bridge in this first end position of the mounting profile is at least partially sunk into one of the first and second connection bridges.

2. Piece of furniture according to claim 1, wherein the mounting profile is guided along rails on the upper side or the lower side and/or the door has several door elements, of which one door element is held by a guide carriage which is displaceable along a guide rail which comprises a first rail part extending along a front side of the piece of furniture and a second rail part extending inside the door compartment, which first and second rail part are connected to each other by a rail curve.

3. Piece of furniture according to claim 1, wherein at least one of the four lever units comprises two plate-shaped lever elements which are arranged at a distance from one another and are connected detachably or as legs of a U-profile fixedly to one another.

4. Piece of furniture according to claim 1, wherein the centre bridge has in cross-section an L-profile, or a U-profile or an H-profile.

5. Piece of furniture according to claim 1, wherein
a) the first and second lever units can be at least partially turned into the centre bridge, or
b) that the third and the fourth lever units are at least partially turnable into the centre bridge, or
c) that all lever units are at least partially turnable into the centre bridge.

6. Piece of furniture according to claim 1, wherein the first connecting bridge has an L-profile or a U-profile, or that the second connecting bridge has an L-profile or a U-profile, or that the first and the second connecting bridge have an L-profile or a U-profile.

7. Piece of furniture according to claim 1, wherein,
a) that the first and second lever units are at least partially turnable into the first connection bridge, or
b) that the third and the fourth lever units are at least partially turnable into the second connection bridge, or
c) that the first and the second lever units are at least partially turnable into the first connection bridge and that the third and the fourth lever units are at least partially turnable into the second connection bridge.

8. Piece of furniture according to claim 1, wherein
a) that the centre bridge is at least partially insertable into the first connection bridge, or
b) that the centre bridge is at least partially insertable into the second connection bridge, or
c) that the centre bridge is at least partially insertable into the first and second connection bridges.

9. Piece of furniture according to claim 1, wherein the first connection bridge is insertable into the second connection bridge or that the second connection bridge is insertable into the first connection bridge.

10. Piece of furniture according to claim 1, wherein in the region of the door compartment at least one bearing element, such as a roller or a sliding element, is provided on which the door is supported or can be supported.

11. Piece of furniture according to claim 1, wherein the first and second lever units are connected by lever joints on one side each to the first connecting bridge and on the other side each to the centre bridge, and in that the third and the fourth lever units are connected by lever joints on one side each to the second connecting bridge and on the other side each to the centre bridge.

12. Piece of furniture according to claim 11, wherein the distance between the lever joints and thus the distance between the associated axes of rotation of at least one of the lever units is adjustable or that the distance between the lever joints and thus the distance between the associated axes of rotation of the third and the fourth lever unit is adjustable.

13. Piece of furniture according to claim 11, wherein at least one of the lever units provided with at least one adjusting device by means of which the distance between two corresponding lever joints of the respective lever unit is adjustable.

14. Piece of furniture according to claim 13, wherein the adjustment device comprises a bearing block which is mounted in the associated lever unit so as to be displaceable along the longitudinal axis thereof and which is adjustable by means of an adjustment screw that held rotatably and axially non-displaceably and which bearing block holds a joint shaft of the associated lever joint.

15. Piece of furniture according to claim 1, wherein the first lever unit is pivotally connected to a first balancing lever and the third lever unit is pivotally connected to a second balancing lever of a balancing device, and in that the first and second balancing levers at the ends facing each other are pivotally connected to a sliding joint, which is mounted in a guide track of the centre bridge so as to be axially displaceable along the centre bridge, or that the second lever unit is pivotally connected to the first balancing lever and the fourth lever unit is pivotally connected to the second balancing lever, and that the first and second balancing lever at the ends facing one another are pivotally connected to a sliding joint which is mounted in a guide track of the centre bridge so as to be axially displaceable along the centre bridge.
